(19) United States
(12) Patent Application Publication
(10) Pub. No.: US 2007/0274288 A1
(43) Pub. Date: Nov. 29, 2007

(54) SHARING RESOURCES IN A WIRELESS COMMUNICATION SYSTEM

(75) Inventors: Jack A. Smith, Valley View, TX (US); Hao Bi, Lake Zurich, IL (US); Sean M. McBeath, Keller, TX (US); James M. O'Connor, Dallas, TX (US); Danny T. Pinckley, Arlington, TX (US); John D. Reed, Arlington, TX (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/680,671

(22) Filed: Mar. 1, 2007

Related U.S. Application Data
(60) Provisional application No. 60/747,946, filed on May 23, 2006.

(51) Int. Cl. H04L 12/28

(52) U.S. Cl. 370/351

(57) ABSTRACT

During operation a wireless terminal will receive instructions assigning it to a group of wireless terminals sharing a common set of resources. The terminal will also receive an overflow allocation policy indicating resources that are to be utilized if there are more assigned resources that group resources.

### FIELD OF THE DISCLOSURE

The present disclosure relates generally to wireless communications and more particularly to sharing time-frequency resources among groups of wireless communication terminals.

### BACKGROUND OF THE DISCLOSURE

In wireless communication systems, it is generally desirable to reduce overhead associated with signaling for voice and data services, system information, control, etc. In traditional cellular systems such as that defined by the High Rate Packet Data (HRPD) standard and the Universal Mobile Telecommunications System (UMTS), bearer establishment is enabled through dedicated signaling. The bearer defines radio parameters, for example, time slot, frequency, code, etc., associated with a channel during a call. In voice communications for example a dedicated channel is assigned to each user. In High Speed Downlink Packet Access (HSDPA) systems, transport format and modulation/coding parameters (TFRI) are provided using dedicated control signaling on a shared control channel, wherein the shared control channel also signals the code channel assigned to the user.

In some data only (DO) systems, voice is served over a voice-over-internet protocol (VoIP). It is known to improve such systems for VoIP traffic using hybrid automatic repeat request (HARQ) error correction schemes and smaller packet sizes. While VoIP users have the same benefits of advanced link adaptation and statistical multiplexing as data users, a greatly increased number of users that may be served because of the smaller voice packet sizes places a burden on control mechanisms of the system. It can be easily envisioned, for example, that 30 times as many voice packets could be served in a given frame than data packets. There are typically about 1500 bytes for data and about 15-50 bytes for voice in a packet, depending on the vocoder rate. In packet based systems the term “data” is meant to signify payload information for any service, voice or data.

It is known to group multiple voice users together which share a set of time-frequency resources. Further, it known to use bitmap signaling to efficiently allocate portions of the shared resource to the set of voice users sharing the same time-frequency resource. However, these techniques do not allow an efficient means of sharing resources among different groups with minimal signaling overhead. Thus, there is a need for efficiently and flexibly sharing resources between multiple groups.

The various aspects, features and advantages of the present disclosure will become more fully apparent to those having ordinary skill in the art upon careful consideration of the following Detailed Description thereof with the accompanying drawings described below. The drawings may have been simplified for clarity and are not necessarily drawn to scale.

### BRIEF DESCRIPTION OF THE DRAWINGS

FIG. 1 is an illustrative wireless communication network.

FIG. 2 is an illustrative sequence of radio frames each comprising a plurality of time slots.

FIG. 3 is an illustrative example of a sequence of repeating radio frames each comprising a plurality of time slots.

FIG. 4 is an illustrative example of a set of shared resources.

FIG. 5 is a schematic diagram of resource assignment information.

FIG. 6 illustrates a resource assignment bitmap.

FIG. 7 illustrates shared resources and an ordering pattern.

FIG. 8 illustrates assignments for multiple groups in the time domain.

FIG. 9 illustrates an exemplary resource allocation policy without this invention.

FIG. 10 is a schematic diagram of resource assignment information.

FIG. 11 illustrates an exemplary resource allocation policy with this invention.

FIG. 12 is a block diagram of a base station.

FIG. 13 is a flow chart showing operation of the base station of FIG. 12.

FIG. 14 is a block diagram of a wireless terminal.

FIG. 15 is a flow chart showing operation of the wireless terminal of FIG. 14.

### DETAILED DESCRIPTION

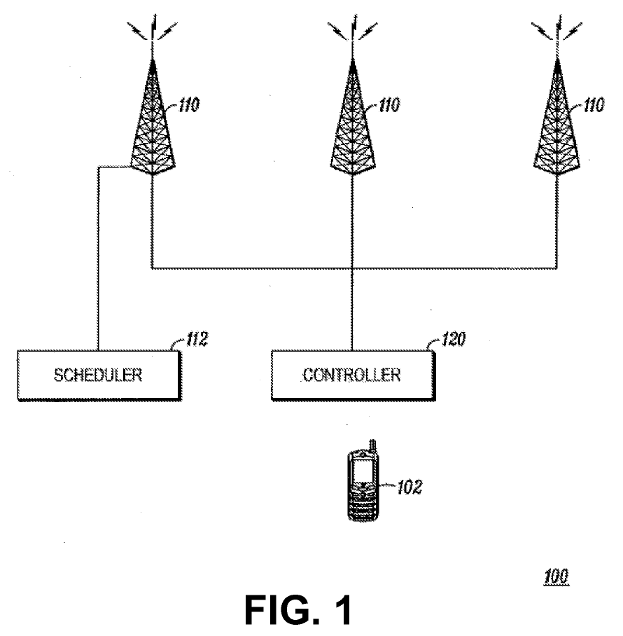

FIG. 1 is a wireless digital communication system 100 comprising a plurality of base transceiver stations 110 providing wireless communication service including voice and/or data service to wireless terminals 102 over corresponding regions or cellular areas. The base transceiver stations (BTS), also referred to by other names such as base station, “Node B”, and access network (AN) depending on the system type, are communicably coupled to a controller 120 and to other entities that are not shown but are well known by those having ordinary skill in the art. In FIG. 1, each base transceiver station includes a scheduling entity 112 for radio resource scheduling among the wireless communication terminals within the network. Exemplary communication systems include, but are not limited to, developing Universal Mobile Telecommunications System (UMTS) networks, Evolved Universal Terrestrial Radio Access (E-UTRA) networks, Evolved High Rate Packet Data (E-HRPD) networks, and other orthogonal frequency division multiplexing (OFDM) based networks.

E-HRDP, E-UTRA and other communication protocols are being developed to support delivery of voice services over a packet domain, in contrast to the traditional delivery of voice over a circuit switched domain. Thus there is interest in schemes that support voice traffic over a shared radio channel, wherein multiple users share the time and frequency resources of the radio interface. In order to attain a significant increase in capacity with E-HRPD and E-UTRA, efficient radio resource allocation schemes will likely be required to accommodate voice traffic. In these and other applications, including data applications, it is generally desirable that control signaling overhead be minimized while offering flexibility to the scheduler at the network. In a general sense, it is useful to define a mechanism to efficiently signal resource allocation and related control channel information to multiple terminals applicable to a broadband wireless system, relying on shared channels for delivery of any service using packet based transmission.

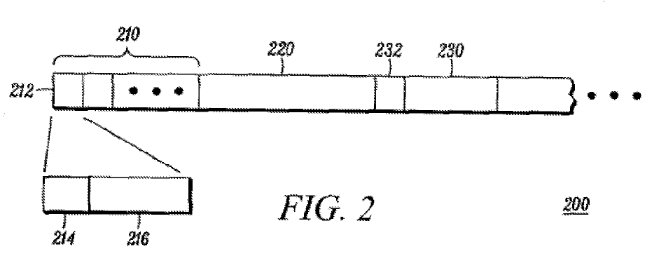

FIG. 2 illustrates a sequence of radio frames 200 useful for communicating in wireless digital communication systems. In FIG. 2, the frame sequence generally comprises a plurality of frames 210, 220, 230 . . . , wherein each frame comprises a plurality of time slots. For example, frame 210 comprises a time slot 212 having a resource assignment control channel portion within a control channel portion 214 and a data channel portion 216. In some embodiments, the frames constitute a repeating sequence of frames, wherein the repeating sequence may be periodic or a-periodic.

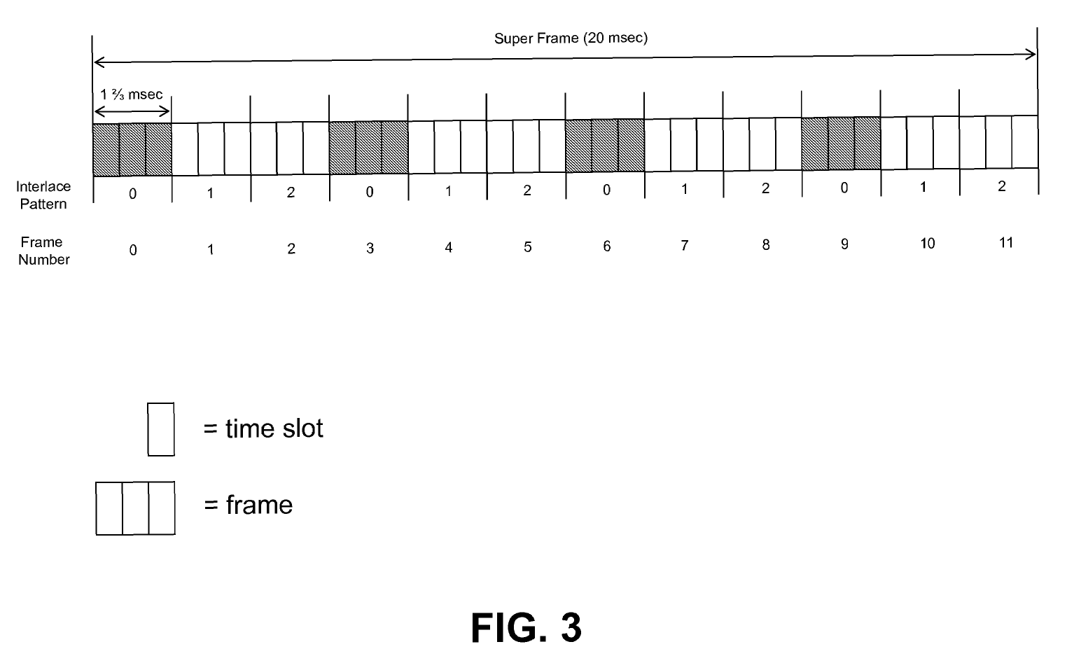

FIG. 3 illustrates a sequence of repeating radio frames, wherein three time slots are grouped to form a frame. In FIG. 3, each time slot is 5/9 msec and each frame is 5/3 msec, although the timing may be different in other embodiments. For example, in another embodiment, two time slots of 5/6 msec are concatenated to form a 5/3 msec frame. In yet another embodiment, one 5/6 msec slot is defined as a frame. An interlace pattern is defined as a repeating sequence of frames. For systems employing synchronous HARQ (S-HARQ), the initial and subsequent transmissions typically occur in the same interlace pattern. In this illustrative example, 12 frames, denoted frame 0 through 11, occupy a 20 msec time interval, which is defined as a super-frame and is the duration of a vocoder frame for many wireless standards.

For orthogonal frequency division multiple access (OFDMA) systems, such as those being considered for E-UTRA and E-HRPD, the frequency domain is divided into subcarriers. For example, for a 5 MHz OFDMA carrier, there may be 464 useful subcarriers, where the subcarrier spacing is 9.6 kHz. Similarly, a time slot is divided into multiple OFDM symbols. For example, a time slot may occupy 5/9 msec and contain 5 OFDM symbols, where each symbol occupies approximately 110.68 usec. The subcarriers are grouped to form frequency selective resource elements (FSRE) and frequency distributive resource elements (FDRE). An FSRE is a group of contiguous subcarriers, while an FDRE is a group of noncontiguous sub-carriers.

In one embodiment, a scheduler or other infrastructure entity in a wireless communication system groups wireless communication terminals in one or more groups for scheduling purposes. Any entity or terminal that may be scheduled by the scheduler is referred to as a schedulable wireless communication entity. In one embodiment, the entities or terminals can be grouped based on radio channel conditions associated with the terminals, for example, channel quality information reported by the terminals, Doppler reported by the terminal, distance from the serving cell, among others. In another embodiment, the terminals are grouped based on one or more terminal operating characteristics other than participation in a common communication session. Exemplary terminal operating characteristics include power headroom of the terminals, macro diversity considerations, terminal capability, service of the terminals, codec rate among others. In yet another embodiment, terminals with an active VoIP session are grouped together. Once the scheduler establishes a group of wireless communication terminals, the BTS sends an indication to each wireless terminal of its position in the group and an indication of the identifier for the group. The identifier for the group is used if the BTS needs to send control information valid for the entire group. For example, the BTS may change the frequency allocation for the group by sending an indication of the group identifier and an indication of the new frequency allocation. The indications can be sent for each wireless terminal separately or can be sent for a plurality of wireless terminals at once. For example, the BTS can transmit a list of wireless terminal unique identifiers along with a group identifier. The first terminal in the list of unique identifiers is assigned the first position, the second terminal in the list of unique identifiers is assigned the second position, etc. The unique identifier can be a mobile communication device or wireless terminal identification number, a subscriber identity, or any other identifier that can be used to uniquely identify a wireless terminal. For example, the unique identifier can be a medium access control index (MAC Index). As another example, the BTS can transmit the unique identifier for one wireless terminal, an identification of the group identifier, an indication of the wireless terminal's position within the group. The indications can be transmitted on a control channel.

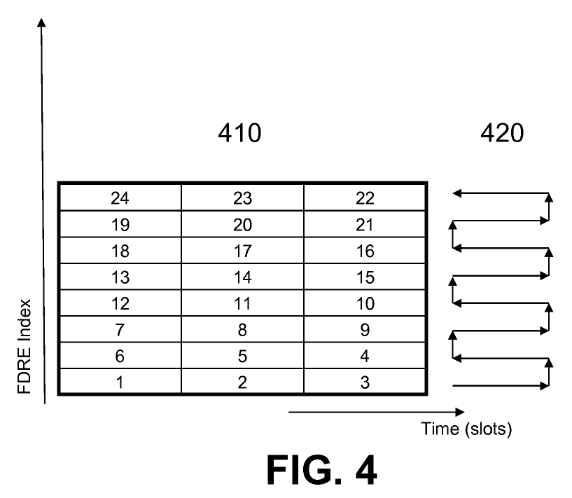

For each group of schedulable wireless communication entities, the scheduler can assign a set of time-frequency resources to be shared by the entities or terminals in the group. FIG. 4 shows an example of a set of shared resources. In FIG. 4, the shared resources 410 are three time slots and eight FDREs. If a block is defined as one time slot in the time domain and one FDRE in the frequency domain, then there are 24 blocks, denoted 1 through 24. Recall that FDREs are groups of non-contiguous subcarriers, so the FDRE Index of FIG. 4 is a logical representation of the frequency domain. As will be discussed later, each wireless terminal determines its portion of the shared resource, based on the assignments for other wireless terminals. Therefore, it is necessary to define the order in which the resources are to be allocated. In FIG. 4, an illustrative ordering pattern 420 is given which results in the blocks being numbered 1 through 24. The set of shared resources can be repeated using an interlace pattern as described in FIG. 3. For example, the 24 resources can be repeated in each frame of interlace pattern 0 in FIG. 3.

The indication of the group identifier and group position can be signaled from the BTS to the wireless terminal using a control channel. Further, the control channel can be transmitted in any time slot prior to the beginning time slot of the set of shared resources or in the same time slot that the set of shared resources begins. The set of shared resources can begin in the same slot the control channel is transmitted, can have a fixed starting point relative to the time slot that the control channel is transmitted, or can be explicitly signaled in the control channel.

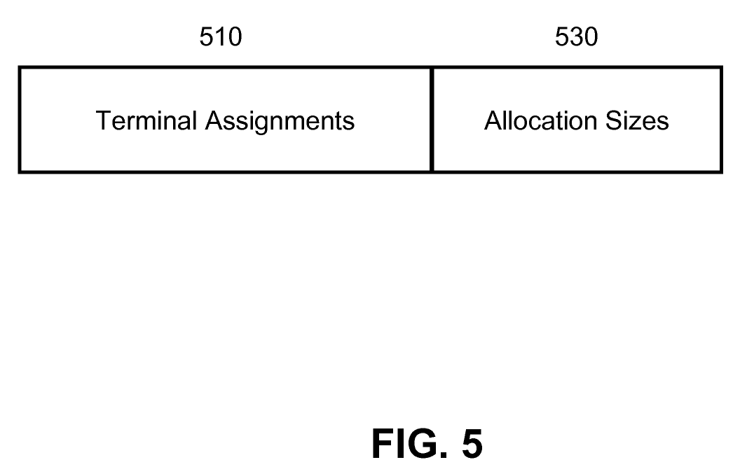

Once the scheduler assigns a plurality of wireless terminals to a group of wireless terminals, assigns each wireless terminal a position (also called location) within the group, assigns a set of shared resources to the group of wireless terminals, the scheduler must indicate to the set of wireless terminals which wireless terminals are active in a given time period and, in some embodiments, the number of assigned resources assigned to each wireless terminal. FIG. 5 is an exemplary technique for assigning resources to wireless terminals. In FIG. 5, a first field 510 indicates which wireless terminals are assigned at least one of the shared resources in the corresponding set of shared resources. For example, 510 could be a first bitmap, where the position of the wireless terminal within the group of wireless terminals corresponds to its bitmap position. For example, the wireless terminal assigned position 0 determines if it is assigned one of the shared resources using position 0 of the bitmap, the wireless terminal assigned position 1 determines if it is assigned one of the shared resources using position 1 of the bitmap, etc. While a bitmap position is typically one bit, it is understood that a bitmap position can be more than one bit. For example, a bitmap position can consist of two bits, where the wireless terminal assigned position 1 determines if it is assigned one of the shared resources using the first two bits of the bitmap, the wireless terminal assigned position 2 determines if it is assigned one of the shared resources using the third and fourth bits in the bitmap, etc. When one bit per wireless terminal is used in the bitmap, active users can be indicated using either a ‘0’ or a ‘1’, where inactive users are indicated using the opposite state. In the illustrative examples, active users are indicated using a ‘1’. In some embodiments, a single bit, denoted the invert ordering pattern bit, is appended to the first bitmap, where the value of the bit indicates whether to follow the ordering pattern in ascending or descending order. For example, a ‘0’ can indicate to use ordering pattern in ascending order (not inverted), while a ‘1’ can indicate to use the ordering pattern in descending order (inverted). The bit can have any location within the first bitmap, as long the wireless terminals know its location.

In FIG. 5, the allocation sizes field 530 indicates radio resource assignment weighting information to the schedulable wireless communication entities to which radio resources have been assigned. In one embodiment, the radio resource assignment weighting information indicates a proportion of radio resources assigned to each schedulable wireless communication entities to which radio resources have been assigned. In another embodiment, the radio resource assignment weighting information indicates a specified number or size of radio resources assigned to each schedulable wireless communication entity to which radio resources have been assigned. In some embodiments, the radio resource assignment weighting information also includes at least one of vocoder rate, modulation, and coding information. If there is only one possible weighting value, the allocation sizes field 530 can be omitted.

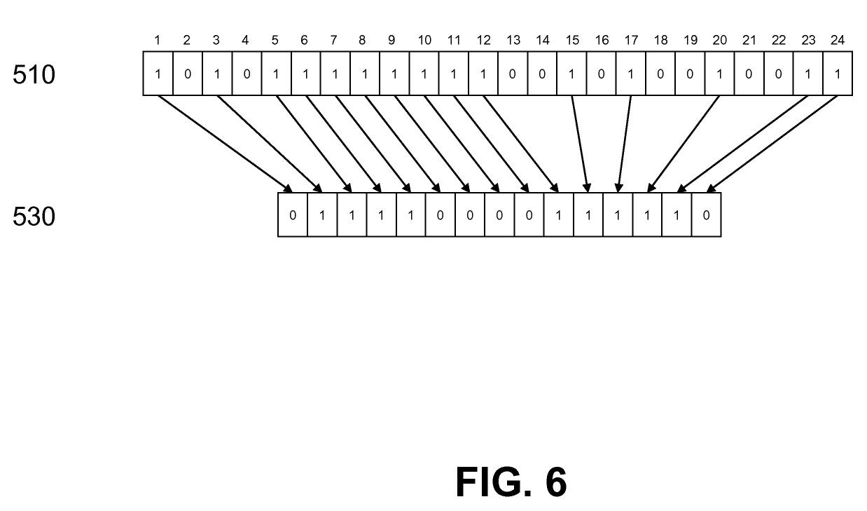

As an illustrative example, FIG. 6 shows an exemplary first and second bitmaps for allocating resources. In FIG. 6, 24 wireless terminals are assigned to a group of wireless terminals and are assigned group positions 1 through 24, which correspond to positions 1 through 24 in the first bitmap. Active wireless terminals are indicated with a ‘1’ in the first bitmap. The first bitmap is the terminal assignments field 510 from FIG. 5. The allocation sizes field 530 is a second bitmap, wherein the Nth active user in the first bitmap corresponds to the Nth position in the second bitmap. A ‘0’ in the allocation size field indicates that 1 resource is allocated to the corresponding wireless terminal and a ‘1’ indicates that 2 resources are allocated to the corresponding wireless terminal. The wireless terminal assigned group position 1, denoted WT₁, and therefore position 1 in the first bitmap is an active wireless terminal as indicated by the ‘1’ in bitmap position 1. Therefore, WT₁ determines its allocation size using the first position in the second bitmap 530. Since a ‘0’ is indicated in the first position in the second bitmap, WT₁ is allocated 1 resource. The wireless terminal assigned group position 2, denoted WT₂, and therefore position 2 in the first bitmap is not an active wireless terminal as indicated by the ‘0’ in the first bitmap. Therefore, WT₂ is not allocated any resources and is not found in the second bitmap 530. The wireless terminal assigned group position 3, denoted WT₃, and therefore position 3 in the first bitmap is an active wireless terminal as indicated by the ‘1’ in bitmap position 3. WT₃ is the second active wireless terminal indicated in the first bitmap and, therefore, WT₃ determines its allocation size using the second position in the second bitmap 530. Since a ‘1’ is indicated in the second position in the second bitmap, WT₃ is allocated 2 resources. These allocation policies are repeated for all 24 wireless terminals. Note that the second bitmap could be the same size as the first bitmap, which would eliminate the need to map assigned terminals in the first bitmap to positions in the second bitmap.

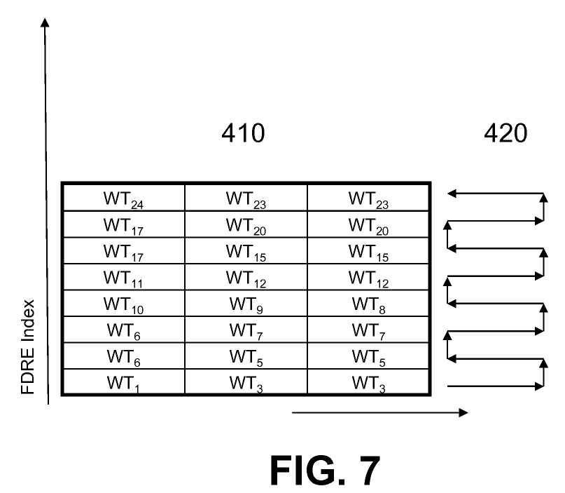

Combining the allocation policies illustrated in FIG. 6 and the set of shared resources 410 and ordering pattern 420 illustrated in FIG. 4, each wireless terminal can determine its portion of the shared resources as depicted in FIG. 7. The first active wireless terminal, WT₁, is assigned one resource, and since it's the first wireless terminal allocated, it is allocated resource 1 of FIG. 4. The second active wireless terminal, WT₃, is assigned two resources. WT₃ must sum the number of resources allocated to wireless terminals with a smaller position in the second bitmap. In this case, WT₃ must determine that one resource was previously assigned. Therefore, WT₃ is assigned resource 2 and 3 of FIG. 4. The third active wireless terminal, WT₅, is assigned two resources. WT₅ must sum the number of resources allocated to wireless terminals with a smaller position in the second bitmap. In this case, WT₅ must determine that 3 resources were previously assigned (1 for WT₁ and 2 for WT₃). Therefore, WT₅ is assigned resources 4 and 5 of FIG. 4. This process is repeated for all wireless terminals.

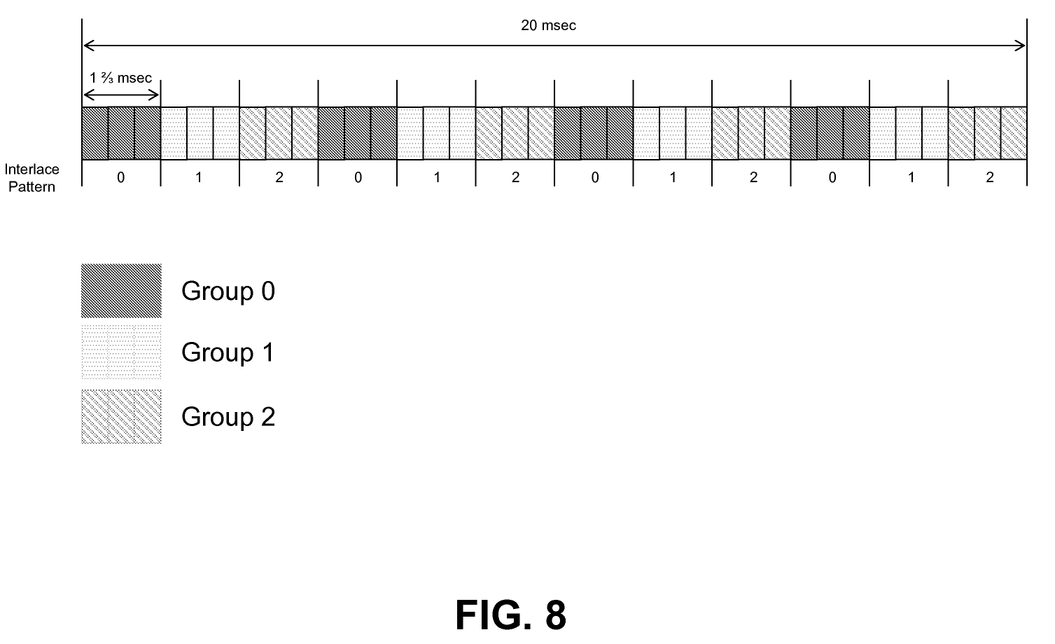

The set of shared time-frequency resources assigned to a group of wireless terminals typically comprises an interlace pattern, as depicted in FIG. 3. For example, referring to FIG. 3, a group of wireless terminals can be assigned a set of FDREs in each of the three time slots in each occurrence of interlace pattern 0. Similarly, a different group of wireless terminals can be assigned the same set of FDREs or a different set of FDREs in each occurrence of interlace pattern 1, and yet another group can be assigned the same set of FDREs or a different set of FDREs in each occurrence of interlace pattern 2. The time domain aspect of this concept is depicted in FIG. 8, where three groups (Group 0, Group 1, and Group 2) of wireless terminals are assigned to interlace patterns 0, 1, and 2, respectively. The interlace pattern assignments represent the time domain assignment for each group. Each group will also be assigned a set of frequency domain resources, where the combination of the time domain resources and the frequency domain resources represent the set of shared time-frequency resources. As previously mentioned, the set of frequency resources assigned to Group 1, 2, and 3 may be different. Further, the number of frequency resources assigned to each group may be different. Finally, the type of frequency resources assigned to each group may be different; i.e. one group may be assigned FSREs, while the other groups are assigned FDREs.

Typically, more users are assigned to each group than can be simultaneously supported. This is due to the following two forms of statistical multiplexing. First, for certain types of service, packets do not need to be transmitted to each wireless terminal in each super frame. To understand this, consider the VoIP case. Recall that, in cdma2000 1xEV-DV, there are four transmission formats for voice (full rate, half rate, quarter rate, and eighth rate). The vocoder frame rate is proportional to the amount of information being transmitted, where eighth rate frames carry the least amount of information. In fact, eighth rate frames simply contain an indication of the background noise level. Consequently, the BTS only needs to transmit every Nth eighth rate frame, where N is typically between 8 and 32. When the BTS does not transmit a VoIP packet to a particular wireless terminal, the term discontinuous transmission (DTX) is commonly used. The second form of statistical multiplexing relates to HARQ. In particular, once a wireless terminal acknowledges its packet, it does not require additional resources within the current super frame, which frees resources for other wireless terminals.

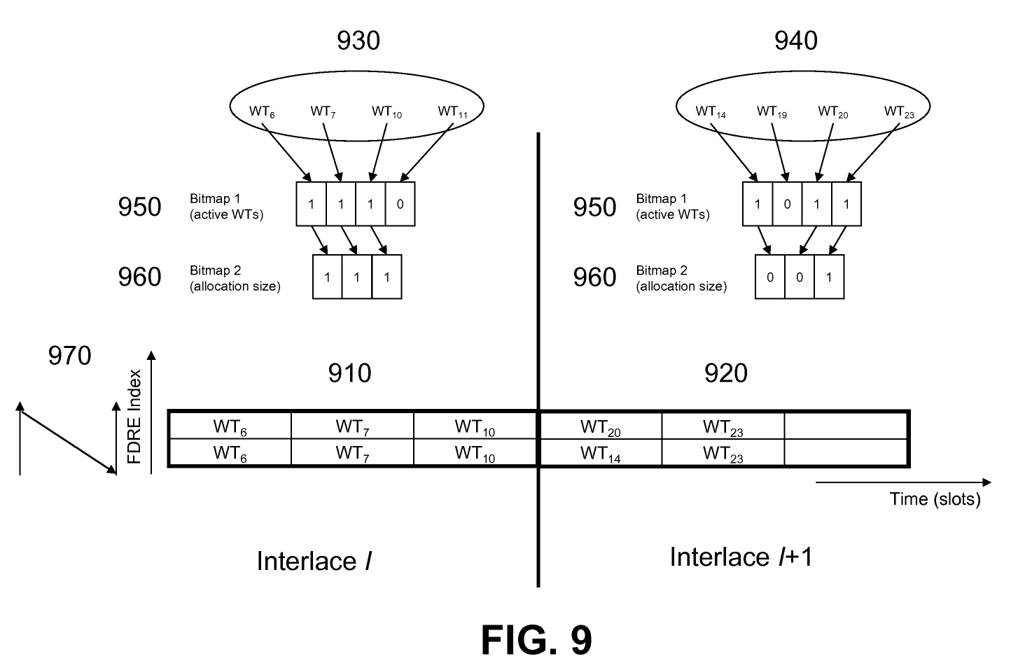

Under certain circumstances, there are more wireless terminals in a particular group that require service in a particular scheduling instance than there are resources. For example, depending on the exact packet arrival rate, there may be more wireless terminals needing resources than there are available resources. For real time services, such as VoIP, this leads to blocking and may eventually result in an outage state for the VoIP user. Further, under certain circumstances, a different group, possibly an adjacent group in time or frequency, will have more resources than users in a particular scheduling instance. As an illustrative example of the simultaneous occurrence of these two scenarios, consider the example depicted in FIG. 9. Referring to FIG. 9, two adjacent interlaces, denoted interlace I and interlace I+1, are defined. Two groups of wireless terminals are assigned frequency domain resources within the two interlaces. In particular, the set of shared frequency domain resources for each interlace is comprised of two FDREs are for a total of 6 blocks (2 FDRE times 3 time slots in each frame) 910 and 920 comprising the shared set of time-frequency resources. Consider that WT₆, WT₇, WT₁₀, and WT₁₁, have been assigned to Group 0 930, and Group 0 is assigned the 6 blocks in interlace I as its shared resources. Further, consider that WT₁₄, WT₁₉, WT₂₀, and WT₂₃ have been assigned to Group 1 940, and Group 1 is assigned the 6 blocks of Interlace I+1 as its shared resources. Further, consider that the BTS uses two bitmaps to schedule wireless terminals, where the first bitmap 950 indicates active wireless terminals, and the second bitmap 960 indicates the size of the allocation for each active wireless terminal as previously described. Consider the case where a ‘0’ in the second bitmap indicates that one block is assigned, and a ‘1’ in the second bitmap indicates that two blocks are assigned. Finally, consider that the scheduler has determined that WT₆, WT₇, WT₁₀, WT₁₁, and WT₂₃ require two resources and that WT₁₄ and WT₂₀ require one resource. Resources are allocated according the ordering pattern 970.

Referring to FIG. 9, the scheduler assigns WT₆, WT₇, and WT₁₀ in interlace I as indicated by the first bitmap of interlace I, which exhausts the set of shared resources. WT₁₁ cannot be assigned resources in this frame. The scheduler assigns WT₁₄, WT₂₀, and WT₂₃ in interlace I+1 as indicated by the first bitmap of interlace I+1, which leaves two unused blocks. Due to the common occurrences of situations where there are wireless terminals that cannot be assigned resources in one group, but where a different group has unused resources, there is a need for a method to instruct users from one group to use the resources group of another with minimal control channel overhead, while still maintaining flexibility.

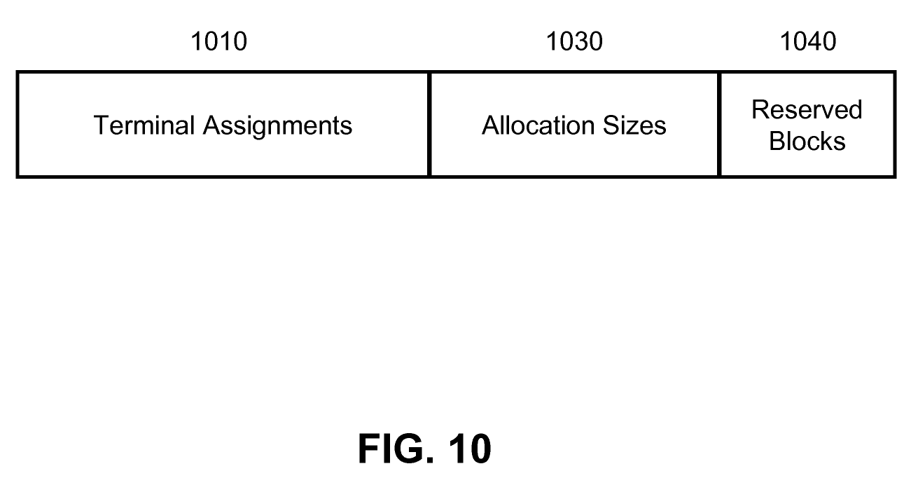

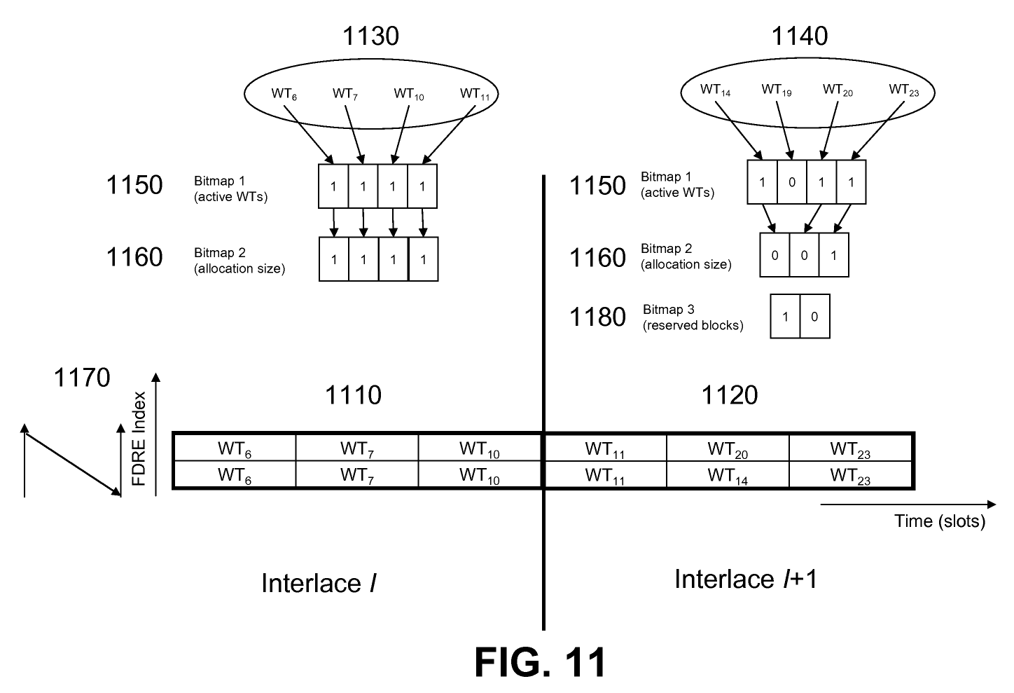

To mitigate the described problem, a new control channel bitmap, denoted reserved blocks field, is transmitted to the group of wireless terminals sharing a set of time-frequency resources to indicate to the group the number of blocks that are being used by members of a different group. The new field is depicted in FIG. 10, where the reserved blocks field 1040 is appended to the previously defined terminal assignments 1010 and allocation sizes 1030 fields. Note that the reserved blocks field can occur in any location within the control channel. For example, in another embodiment, the reserved blocks field occurs before the terminal assignments 1010 and allocation sizes 1030 fields. By combining the reserved blocks field with an overflow allocation policy to handle the cases when more resources are assigned than are available, resources can be shared amongst groups. As an example, FIG. 11 is provided which illustrates sharing resources between groups occupying adjacent interlaces. The scenario of FIG. 11 is the same as that described for FIG. 9.

Referring to FIG. 11, the scheduler instructs the group assigned to interlace I that their overflow resources are those typically used by the group assigned to interlace I+1 beginning with the first resource. Such instructions will be denoted as the overflow allocation policy. The BTS can explicitly indicate the time and frequency resources of the overflow allocation policy, or can simply indicate the group identifier of another group as the overflow allocation policy. For example, referring to FIG. 11, if a group identifier is used, the wireless terminals of the group assigned to interlace I must know the set of shared resources 1120 and ordering pattern 1170 of interlace I+1. Further, the wireless terminals of the group assigned to interlace I+1 must know the overflow allocation policy, so they know which resources have been used by wireless terminals assigned to a different group. Each of these instructions can be indicated using a control channel message or can be stored at the wireless terminal as a default value. Returning to FIG. 11, if any wireless terminal assigned to the group assigned to interlace I observes that more resources are assigned than are defined as the set of shared resources, the wireless terminal knows to use the resources of the group assigned to interlace I+1 starting at the beginning according to the overflow allocation policy. Since the overflow allocation policy defines the overflow resources as the first resource of the adjacent group, a new control channel bitmap, denoted the reserved blocks field 1180, is transmitted to the group of interlace I+1 to inform the group of the number of resources being used by the group of interlace I. Referring again to FIG. 11, recall that the scheduler has determined that WT₆, WT₇, WT₁₀, WT₁₁, and WT₂₃ require two resources and that WT₁₄ and WT₂₀ require one resource. In the normal allocation policy, WT₁₁ cannot be served, since WT₆, WT₇, WT₁₀ exhaust the set of shared resources of the group assigned to interlace I. However, since there is an overflow allocation policy, the scheduler can indicate that WT₁₁ is active in interlace I. When determining its resources, WT₁₁ will observe that more resources are allocated in interlace I than are defined in the set of shared resources. WT₁₁ then knows to use the first two blocks of interlace I+1, due to the overflow allocation policy. The wireless terminals in interlace I+1 are made aware of the fact that other wireless terminals are using two blocks of their set of shared resources through a third the third bitmap 1180, which indicates that two (binary ‘10’) blocks are reserved for wireless terminals from another group. Therefore, the wireless terminals assigned to interlace I+1 begin allocating resources at block number 3. Note that the wireless terminals assigned to interlace I do not have to decode the three bitmaps for the group assigned to interlace I+1.

Notice in FIG. 11 that ordering pattern 1170 indicates that the resources are allocated in the first slot for all FDREs, and then in the second slot for all FDREs, and then in the third slot for all FDREs. This ordering allows the users that are shifted from interlace I to interlace I+1 to typically occur in the first slot of interlace I+1, thereby providing the maximum amount of time for these wireless terminals to decode the transmission and respond with an acknowledgement or negative acknowledgement.

In an alternate embodiment, the overflow allocation policy indicates that wireless terminals overflowing in a certain group, say Group A, are to begin using the resources of another group, say Group B, beginning at the end of the set of shared resources and in descending order according to the ordering pattern. For these cases, the reserved blocks field is not always necessary. For example, if Group B does not have an overflow allocation policy, then it does not need to know the number of blocks taken by users of Group A, since the scheduler will guarantee there is no overlap. However, if Group B users have an overflow allocation policy relating to the shared resources of another group, say Group C, then the users of Group B will need to know when their resources are exhausted, thereby requiring the reserved blocks field. For example, when the groups correspond to interlaces, it is envisioned that one interlace will have a certain overflow allocation policy, which can be different than the next interlace in the same sector. For example, some interlaces may be loaded higher than others to achieve certain SINR by way of a reuse pattern, thereby requiring different overflow allocation policies.

In some embodiments, two overflow allocation policies are allocated to a group of wireless terminals. The first overflow allocation policy is used when the invert ordering pattern bit is set to ‘0’, and the second overflow allocation policy is used when the invert ordering pattern bit is set to ‘1’.

Resources can be shared by groups separated in the time domain, as in the example above. Alternatively, resources can be shared by groups separated in the frequency domain. For example, if there are two groups in a particular interlace, say Group D and Group E, where each group is assigned distinct resources in the frequency domain, then the overflow allocation policy of Group D can be to use the resources of Group E. Further, more than one overflow allocation policy can be defined for a group of wireless terminals. For example, the first overflow allocation policy could indicate to Group F to use the first resources of Group G, up to a maximum of 3 blocks. The second overflow allocation policy could indicate to Group F to use the first resources of Group H, only after the three blocks of Group G are exhausted.

The reserved blocks field is an indication to the users of a group concerning the number of resources being used by members of another group. Typically, this bitmap will be a direct mapping of binary to decimal. For example, if three bits are allocated for the reserved blocks field, then ‘000’ indicates that 0 blocks are reserved, ‘001’ indicates that 1 block is reserved, ‘010’ indicates that 2 blocks are reserved, ‘011’ indicates that 3 blocks are reserved, etc. However, other mappings are possible. For example, a simple non-linear representation of the three bits could be used such that ‘000’ indicates that 0 blocks are reserved, ‘001’ indicates that 1 block is reserved, ‘010’ indicates that 2 blocks are reserved, ‘011’ indicates that 4 blocks are reserved, ‘100’ indicates that 8 blocks are reserved, ‘101’ indicates that 12 blocks are reserved, ‘110’ indicates that 16 blocks are reserved, ‘111’ indicates that 32 blocks are reserved. Any linear or non-linear mapping of the reserved blocks field to the actual number of reserved blocks is possible, as long as the scheduler at the BTS and the wireless terminals know the mapping. It is envisioned that more resources may be reserved than end up being used, and, although this is slightly inefficient, it is sometimes desirable. For example, it reduces the overhead in the reserved field used in specifying the number of resource blocks reserved when non-linear mappings are used. The mapping can be transmitted on a control channel or can be stored at the wireless terminal as a default value.

Thus, according to the above-described technique for allocating resources, all terminals are assigned a particular resource block within a first set of shared resource blocks via a bitmap, and will choose the particular resource from the resource block according to a fill, or ordering pattern. A first terminal will acquire a first resource block, a second terminal will acquire a second resource block, . . . etc, where the resource blocks for different terminals can have different sizes. Since all terminals receive the bitmap, all terminals will know who was allocated resources before them. Using this information, and the fill pattern, they will know what resources to utilize for their communications. Additionally, a terminal will know if there are any remaining resources in a particular resource block. If no resources exist for a terminal, the terminal will utilize resources from a second set of shared resource blocks. The terminal will not announce this; instead the terminal will simply begin utilizing the resources from the second set of shared resource blocks according to an overflow allocation policy, known by all terminals.

The base station, too, will realize if there are no remaining resources within the first set of shared resource blocks. When this is determined, the base station will send out a “reserved blocks” field to the terminals using the second set of shared resource blocks. This will notify the terminals of the second set of shared resource blocks how many of its resource blocks were filled. The users of the second set of shared resource blocks will continue filling the resource blocks according to the fill, or ordering pattern.

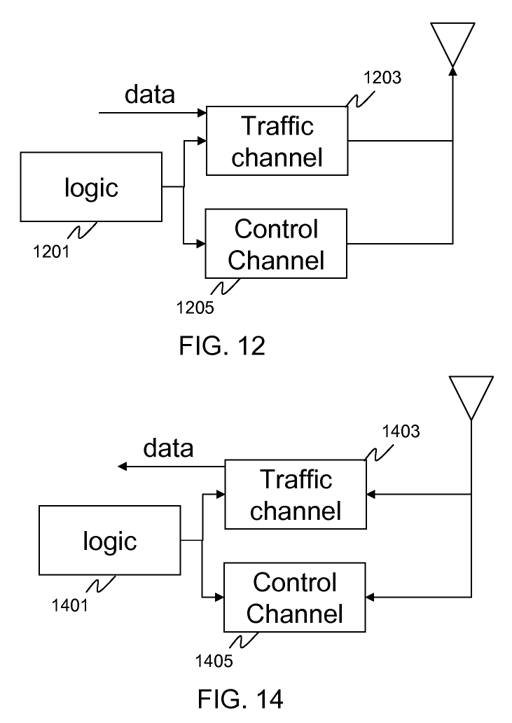

FIG. 12 is a block diagram of a base station. As shown, base station 110 comprises logic circuitry 1201, traffic channel circuitry 1203, and control channel circuitry 1205. During operation, data enters traffic channel circuitry 1203 and is transmitted to the appropriate wireless terminal 102 utilizing the appropriate shared resource from a set of shared resources (i.e., time slot(s) and subcarrier(s), possibly within a particular interlace).

As described above, control channel circuitry 1205 transmits appropriate control information to a set of terminals 102. The control information comprises terminal assignments 1010 that notify each terminal of its particular terminal “order”. Allocation sizes 1030 are also transmitted by control channel circuitry 1205. As discussed above, the allocation size comprises an amount of the shared resources that a particular terminal will occupy.

When logic circuitry 1201 determines that a particular group of terminals will not have the necessary resources available in their set of shared resource blocks (e.g., within interlace I), logic circuitry 1201 will determine an amount of excess resources needed, and then instruct control channel circuitry 1205 to broadcast a reserved blocks field 1040 to users of another set of shared resource blocks (e.g., interlace I+1). The reserved blocks field 1040 will indicate to the users of the other set of shared resource blocks exactly how many resources are being utilized by terminals not assigned to their set of shared resource blocks. When the reserved blocks field is received by terminals, they will determine an amount of resources being utilized, and will continue to “fill” their set of shared resource blocks according to a fill, or ordering pattern.

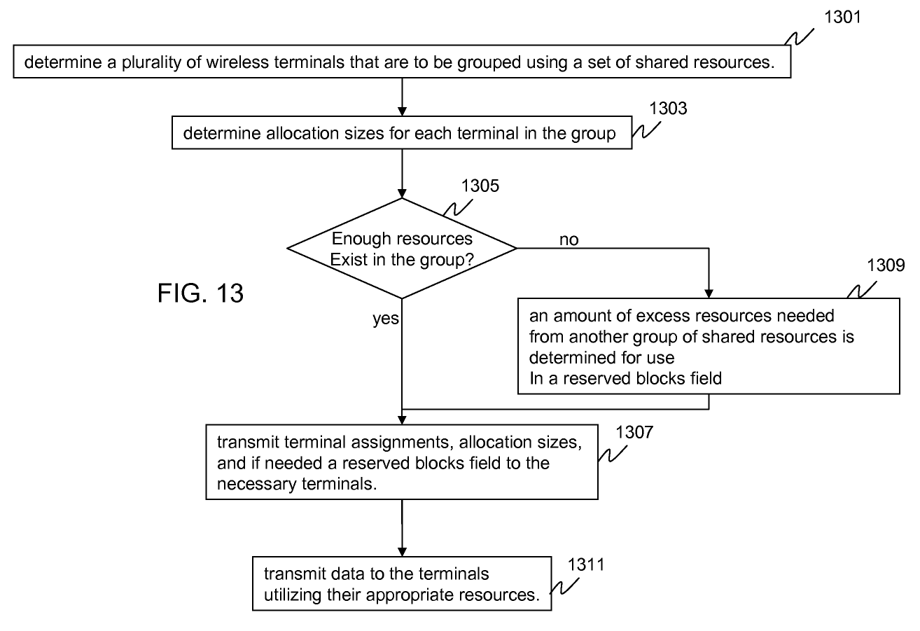

FIG. 13 is a flow chart showing operation of the base station of FIG. 12. The logic flow begins at step 1301 where logic circuitry 1201 (acting as a scheduler) determines a plurality of wireless terminals that are to be grouped using a set of shared resources. As discussed above, all terminals in the group will have a predetermined ordering pattern (fill order) for the resources, and a predetermined overflow allocation policy. The overflow allocation policy will be transmitted to all wireless terminals as part of a control channel message. In particular, the base station can transmit the group identifier and the overflow allocation policy on a control channel. The overflow allocation policy can be an explicit list of resources to use in case of overflow. For example, the overflow allocation policy can be a list of FDRE indices. Alternatively, the overflow allocation policy can be the group identifier of a different group, wherein the wireless terminals receiving the control message know the resources corresponding to the different group. In some embodiments, the group identifier of the different group is accompanied by an offset, instructing the wireless terminals to overflow beginning at the offset. In another embodiment, the group identifier of the different group is accompanied by a maximum number of resource blocks, instructing the wireless terminals to cease using the overflow resources once the maximum number of blocks is reached. Logic circuitry 1201 then determines allocation sizes for each terminal in the group (step 1303), and determines if there exists enough resources in the group to accommodate the allocations (step 1305). If, at step 1305 there exists enough resources in the group, the logic flow continues to step 1307, otherwise, the logic flow continues to step 1309 where an amount of excess resources needed from another group of shared resources is determined for use in the reserved-bocks field.

At step 1307 control channel circuitry 1205 transmits terminal assignments, allocation sizes, and if needed a reserved-blocks field to the necessary terminals. Finally, at step 1311, traffic channel circuitry 1203 transmits data to the terminals utilizing their appropriate resources.

FIG. 14 is a block diagram of a terminal. As shown, terminal 102 comprises logic circuitry 1401, traffic channel circuitry 1403, and control channel circuitry 1405. During operation, data is received via either control channel circuitry 1405 (via a control channel) or traffic channel circuitry 1403 (utilizing the appropriate shared resource from a set of shared resources (i.e., time slot(s) and subcarrier(s) within a particular interlace)).

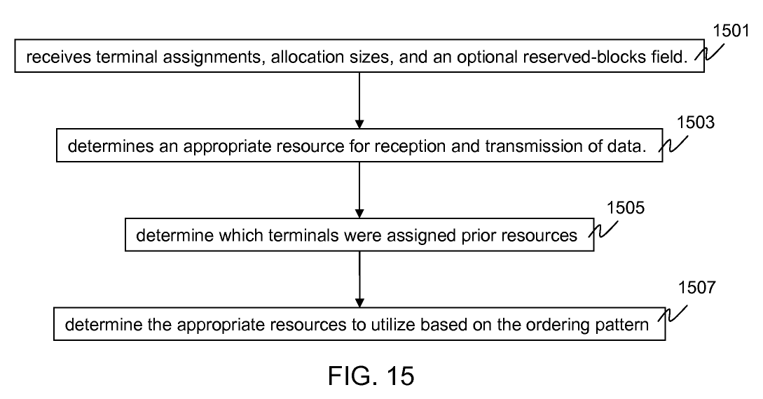

FIG. 15 is a flow chart showing operation of terminal 102. The logic flow begins at step 1501 where control channel circuitry 1405 receives terminal assignments, allocation sizes, and an optional reserved-blocks field. From this information, logic circuitry 1301 determines an appropriate resource for reception and transmission of data 1503. More particularly, logic circuitry 1401 will instruct traffic channel circuitry 1403 to use a particular resource from a set of shared resource blocks according to a fill, or ordering pattern. Logic circuitry 1401 will determine which terminals were assigned prior resources (step 1505) and utilizing this information and allocation sizes, and any reserved blocks, logic circuitry 1401 will determine the appropriate resources to utilize based on the ordering pattern (step 1507). As discussed above, if no resources are available within the terminal's assigned set of shared resource, logic circuitry will instruct traffic channel circuitry 1403 to utilize resource blocks from another group of shared resources according to an overflow allocation policy.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in an access network, the method comprising:
establishing a group of terminals which monitor one or more shared bitmaps to determine their respective resource allocation within group resources, wherein each group of terminals is identified by a group identifier, and the group resources specify a set of shared time-frequency resources which are assigned to the group; and
transmitting a reserved resources field to terminals, wherein the reserved resources field indicates a number of resources, beginning with a first available resource, that are being used by other terminals.

2. The method of claim 1 wherein the one or more shared bitmaps comprises a bitmap corresponding to a terminal indicating if the terminal is active or not.

3. The method of claim 2 wherein the one or more shared bitmaps comprises an allocation sizes bitmap to indicate a number of resources allocated to each active terminal.

4. The method of claim 1 wherein the one or more shared bitmaps comprises an allocation sizes bitmap to indicate a number of resources allocated to each active terminal.

5. A method comprising:
receiving a group assignment, the group assignment containing a group identifier and a position within a bitmap, the group identifier being associated with group resources and the position indicates the bit in a bitmap corresponding to a terminal, the group resources specifying a set of shared time-frequency resources which are assigned to the group;
receiving one or more shared bitmaps;
receiving a reserved resource field indicating the number of resources, beginning with a first available resource, that are being used by other terminals; and
determining a resource allocation using the position within a bitmap, the one or more shared bitmaps, and the number of resources indicated by the reserved resources field.

6. The method of claim 5 wherein the one or more shared bitmaps comprises a bitmap wherein a bit in the bitmap corresponds to a terminal indicating if the terminal is active or not.

7. The method of claim 6, wherein the terminal determines its resource allocation based on the number of resources allocated to terminals with smaller positions within the bitmap.

8. An apparatus comprising:
logic circuitry establishing a group of terminals which monitor one or more shared bitmaps to determine their respective resource allocation within group resources, wherein each group of terminals is identified by a group identifier, and the group resources specify a set of shared time-frequency resources which are assigned to the group; and
a transmitter transmitting a reserved resources field to terminals, wherein the reserved resources field indicates a number of resources, beginning with a first available resource, that are being used by other terminals.

9. The apparatus of claim 8 wherein the one or more shared bitmaps comprises a bitmap wherein a bit in the bitmap corresponds to a terminal indicating if the terminal is active or not.

10. The apparatus of claim 8 wherein the one or more shared bitmaps comprises an allocation sizes bitmap to indicate a number of resources allocated to each active terminal.

11. The apparatus of claim 10 wherein the one or more shared bitmaps comprises an allocation sizes bitmap to indicate a number of resources allocated to each active terminal.
